(19) United States
(12) Patent Application Publication
(10) Pub. No.: US 2002/0032624 A1
(43) Pub. Date: Mar. 14, 2002

(54) Hedge effectiveness test

(76) Inventors: Deane Yang, New York, NY (US); Andrew Kalotay, Spencertown, NY (US); Michael Dorigan, New York, NY (US); Leslie Abreo, Jersey City, NJ (US)

Correspondence Address: Arthur L. Plevy, Esq., Duane, Morris & Heckscher LLP, 100 College Road West, Suite 100, Princeton, NJ, 08540, US

(21) Appl. No.: 09/866,936

(22) Filed: May 29, 2001

Related U.S. Application Data
(60) Provisional application No. 60/207,245, filed on May 26, 2000.

(51) Int. Cl. G06F 17/60

(52) U.S. Cl. 705/30

(57) ABSTRACT

A method and system for determining effectiveness of a hedge on a hedged item is disclosed. The method and system includes determining a standard deviation of changes in value of a hedged item over a known time frame; determining a standard deviation of a combination of the changes in value of the hedged item and changes in value of a hedging vehicle over the known time frame; and, determining a ratio between the determined standard deviations. In another aspect of the invention, a volatility reduction measure is determined as the compliment of the determined ratio and effectiveness is determined when the volatility reduction measure is above a known level.

### FIELD OF INVENTION

The present invention relates generally to accounting principles and more particularly to methods for determining whether a hedge qualifies as effective for purposes of receiving favorable accounting treatment known as “hedge accounting”.

### BACKGROUND OF INVENTION

The usage of hedges in financial markets is well established and accepted. Ideally, hedges eliminate valuation uncertainty of assets or liabilities. In practice however, hedges tend to be imperfect, but nonetheless often serve to advantageously reduce this same uncertainty. Accordingly, there is a need for an objective approach to quantify the performance of hedges.

Further, it is well understood that pursuant to Statement 133 of the Financial Accounting Standards Board (FASB), all derivatives must be marked to market and that changes in value thereof from the previous reporting period be passed to earnings. This may have the undesirable result of undue volatility of reported earnings.

To address this problem, under certain conditions Statement 133 further allows for a hedged item to be marked to market as well. In that case the change in the value of the asset or liability being hedged, i.e. the hedged item, is also passed to earnings thereby offsetting the effect of the change in value of the derivative or hedging vehicle. This treatment, known as “hedge accounting”, has the desirable effect of reducing the undue volatility of earnings.

However, to qualify for hedge accounting the hedge must pass a so-called “effectiveness test”, or in other words be sufficiently “effective”. To date, the FASB has given only general guidelines as to how to construct such an “effectiveness test”. Absent definitive guidance on the subject, corporations are currently expected to devise, apply and defend their own “hedge effectiveness” tests.

One broad guideline provided by the FASB is the 80% -125% rule. The 80% -125% rule compares change in value of the hedging derivative, or hedging vehicle, to that of the hedged item for each observation, or discrete data point. Using this analysis, a hedge is deemed “effective” for statement 133 purposes if the resulting ratio lies between −1.25 and −0.80 every time. In other words, the 80% -125% rule determines if at least 80% of each individual change in value of a hedged item is offset by a corresponding change in value of a hedging vehicle. It does not consider how effectively the overall volatility of the value of the hedged item was reduced by the hedging vehicle.

A shortcoming of the 80% -125% rule is that it fails in stable markets. For example if a derivative, or hedging vehicle, changes in value from $0.00 to $130,000 in a given time frame and the hedged item changes in value from $104,000,000 to $103,900,000 over the same time frame, this approach yields a result of −1.30 ($130,000/$−100,000) which falls outside of the acceptable range even though the hedge is probably performing in an acceptable manner.

Another broad guideline provided is predicated upon regression based testing which calculates the R² of a regression of a change in the hedged item's value and that of the derivative, or hedging vehicle. Using such an analysis, a hedge is deemed “effective” if the R² is at least 80%. This test is less stringent than the 80% -125% rule, but still suffers from significant shortcomings. A regression produces the equation of a line of the form y=a+bx that purports to explain the relationship between variables y and x. If R² is high, then the “goodness of fit” or the explanatory power of the equation is said to be high. However, no mention is made in Statement 133 of the slope coefficient b. Thus if b=0.1, and the change in value of the hedged item (y) is consistently near one-tenth (1/10) the change in value of the hedging vehicle (x), then the R² is near 100% but the hedge is clearly ineffective.

Further, a weakness common to both the 80% -125% rule and the regression based test is that they depend upon the magnitude of changes in value of the hedged item and hedging vehicle relative to one another, without reference to the magnitude of the value of the hedged item. This absence of scale exaggerates the importance of small changes.

As should be understood by those possessing an ordinary skill in the pertinent art, both of these analyses essentially use a point by point comparison with no reference to performance of the hedged item alone. In contrast, the present invention compares overall volatilities and uses the performance of the hedged item as a base case.

Hence, there is a need in the industry for an objective, and more reliable method for determining whether a hedge is “effective” than either the identified 80% -125% rule or the regression based R² rule.

### SUMMARY OF INVENTION

A methodology for determining how effectively a hedge reduces the overall volatility of the value of the hedged item whether it be an asset or liability is disclosed. The method comprises determining a standard deviation of changes in value of a hedged item over a given time frame; determining a standard deviation of a combination of the changes in value of the hedged item and changes in value of a hedging vehicle over the given time frame; and, determining a ratio between the standard deviation of changes in value of the hedged item and the standard deviation of changes in value of the hedged item and changes in value of the hedging vehicle.

### BRIEF DESCRIPTION OF THE FIGURES

Various other objects, features and advantages of the invention will become more apparent by reading the following detailed description in conjunction with the drawings, which are shown by way of example only, wherein:

FIG. 1 illustrates an examplematic volatility of a hedged item;

FIG. 2 illustrates an exemplary volatility of the hedged item shown in FIG. 1 and an exemplary volatility of the hedged item in combination with a hedge package;

FIG. 3 illustrates a preferred form of the method for practicing the present invention; and

FIG. 4 illustrates an exemplary system in accordance with the principles of the invention.

### DETAILED DESCRIPTION OF THE INVENTION

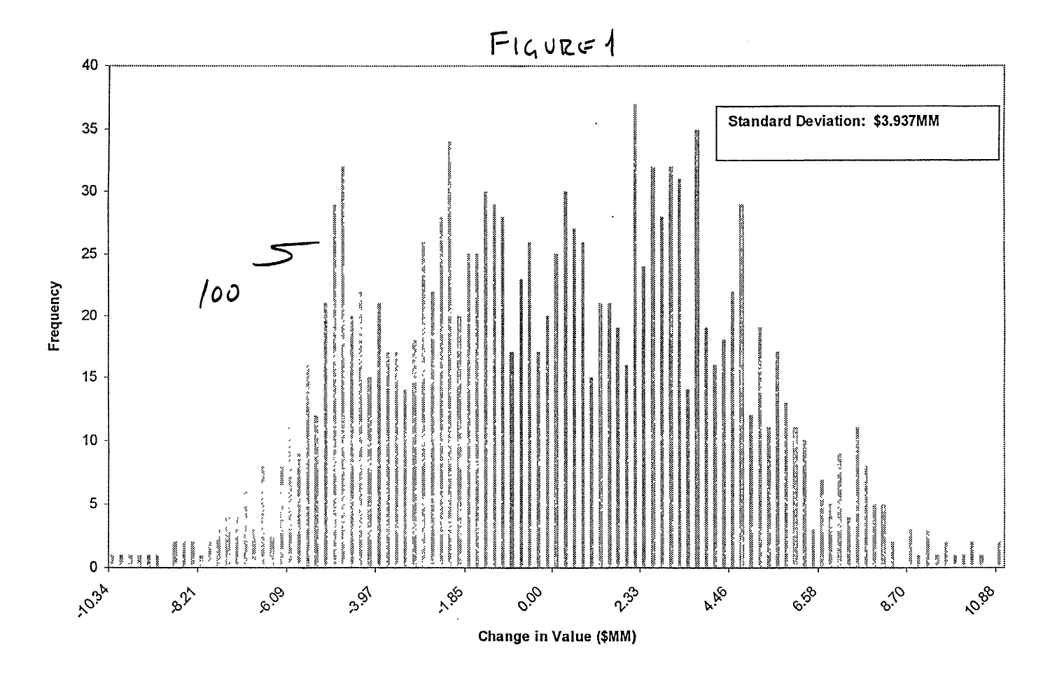

Referring now to FIG. 1, therein is illustrated the frequency distribution 100 of changes in value of a hedged item. In this exemplary case the hedged item is a 10 year, 8% treasury bond and FIG. 1 illustrates historical interest rates changes from May, 1994 till December, 1999. The calculated standard deviation for the hedged item is approximately $3,937,000.

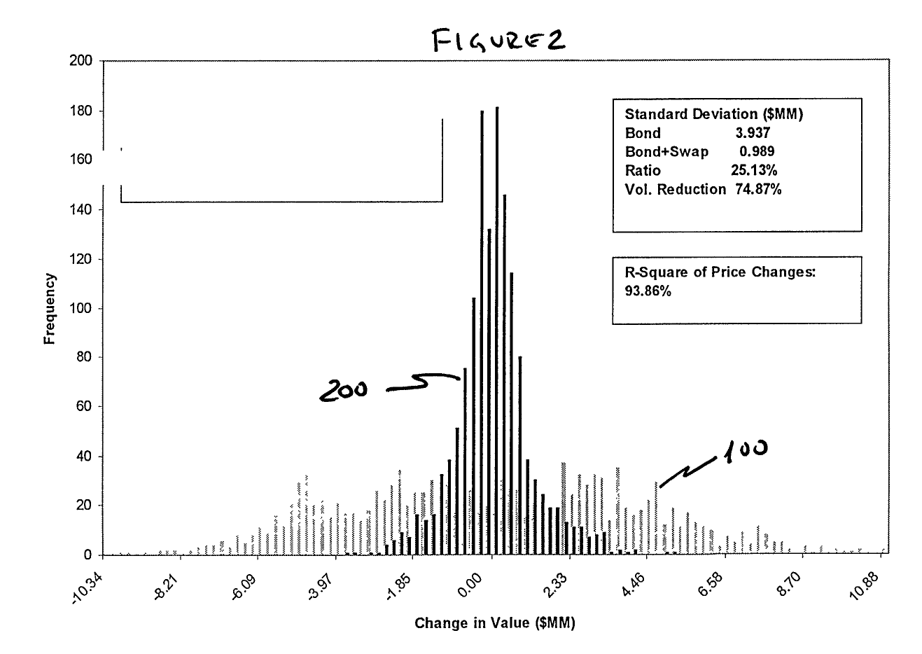

Referring also to FIG. 2, therein is illustrated the frequency distribution 100 referred to in FIG. 1, in conjunction with well as a frequency distribution 200 of changes in value of a combination of the hedged item and a hedging vehicle, in this particular case, a 10 year, 8% LIBOR swap. The face value of the bond and notional amount of the hedging vehicle, referred to as “the swap” are both set to $100,000,000. In this case, the standard deviation for the change in value of the bond, i.e. hedged item, is $3,937,000, while the standard deviation of the bond and swap in combination, i.e. the hedge package, is $989,000.

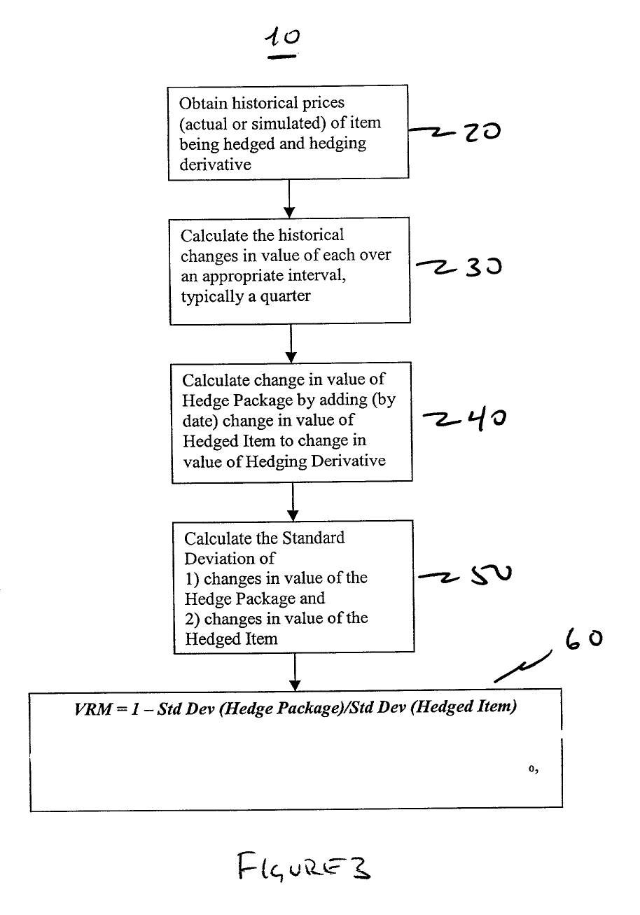

Referring now to FIG. 3, there is illustrated a preferred form of the method 10 for practicing the present invention. In accordance with the principles of the invention, at block 20, historical values for the hedged item and hedging vehicle, i.e. derivative values, are obtained, similar to those shown in FIG. 2. Corresponding values of hedged item and hedging vehicle are obtained over a known time period, e.g., a month, a quarter, a plurality of quarters, yearly, etc. At block 30, the historical changes in value of the hedged item and hedging vehicle over an appropriate time frame, such as a business quarter, are calculated.

At block 40, the changes in value of the hedged item and hedging vehicle (collectively the “hedge package”) are calculated by adding the change in value of the hedged item to the change in value of the hedging vehicle at corresponding dates.

At block 50, the standard deviations for the changes in the value of the hedge package, and the changes in the value of the hedged item are determined.

At block 60, a ratio of the determined standard deviations is determined and a Volatility Reduction Measure (VRM) is determined as the complement of the ratio in accordance with:

$$\begin{matrix}VRM = 1 - \frac{σ ( Δ {value}_{hedge \_ package} )}{σ ( Δ {value}_{hedged \_ item} )} . \\ or & [ 1 ] \\ VRM = 1 - \frac{σ ( Δ {value}_{hedged \_ item} + Δ {value}_{hedging \_ vehicle} )}{σ ( Δ {value}_{hedged \_ item} )} , & [ 2 ]\end{matrix}$$

where

Δvalue_{hedged_item} denotes the change in value of the hedged item of a given timeframe,

Δvalue_{hedging_vehicle} denotes the change in value of the hedging vehicle over the same time frame, wherein the hedged item and hedging vehicle collectively form the hedge package, and

σ denotes the positive square root of the variance of the distribution of the hedged item, i.e., standard deviation

In accordance with the principles of the invention, when the VRM is above a known threshold defined by financial considerations then the hedge can be concluded to be “effective”.

The present invention recognizes and takes advantage of the realization that the performance of a hedged item without the hedge provides a reasonable base case for determining the effectiveness of a hedge. According to the present invention, calculations and determinations are based on changes in value of the hedged item and the combination of the hedged item and hedging vehicle (hedge package). In this example of hedged item and hedge package depicted in FIGS. 1 and, respectively, the ratio of the standard deviation of the change in value of the combination to that of the bond is approximately 0.2513, or 25.13%, and the corresponding VRM is 0.7487 or 74.87%.

It should be noted that if appropriate financial considerations are used to determine that an 80% reduction is the threshold for determining whether a hedge is “effective” for Statement 133 purposes is suitable, this hedge would fail and hence the hedged item would not qualify for hedge accounting. It should also be noted that the before mentioned R² regression based analysis yields a result of 93.86% for this same data which may mislead an observer to conclude that this hedge is very effective at countering the volatility of the bond's value. Quite demonstrably, the present invention does not suffer from this significant shortcoming as it returns a value of 74.87% which is more indicative of the overall effectiveness of the hedge in reducing the value volatility of the hedged item.

The present invention advantageously results in a single Volatility Reduction Measure (VRM) which indicates how effective a hedge is based upon whether inclusion of the hedging derivative, or hedging vehicle, “sufficiently” reduced the volatility of the hedged item's value volatility over the appropriate time frame. It should be understood that the “sufficiency” of volatility reduction is preferably based upon conventional financial considerations.

In other words, the present invention quantifies the reduction in volatility realized by using the hedging vehicle as compared to the volatility of the hedged item itself without using the hedging vehicle. Volatility may be expressed in currency amounts, such as United States Dollars or in percentage terms. By way of particular example, a hedge may be considered effective if at least an 80% reduction in volatility is realized, i.e. VRM≧0.80.

If the determined VRM exceeds a threshold value, such as 0.80 in the example provided above, the hedge is considered “effective”. Again, it should be recognized that if a hedge is considered “effective”, the hedge package, i.e. the hedged item and hedging vehicle, advantageously qualifies for hedge accounting and the undue reported earnings volatility introduced by the value volatility of the hedging vehicle can be advantageously reduced pursuant to Statement 133.

Advantages of the present invention include: its overall simplicity as compared to either the 80% -125% rule or R² regression based test, that it is rigorous, defensible and reasonable, in that the standard deviation reflects actual business risk, and that it takes into account the performance of the hedged item as the base case.

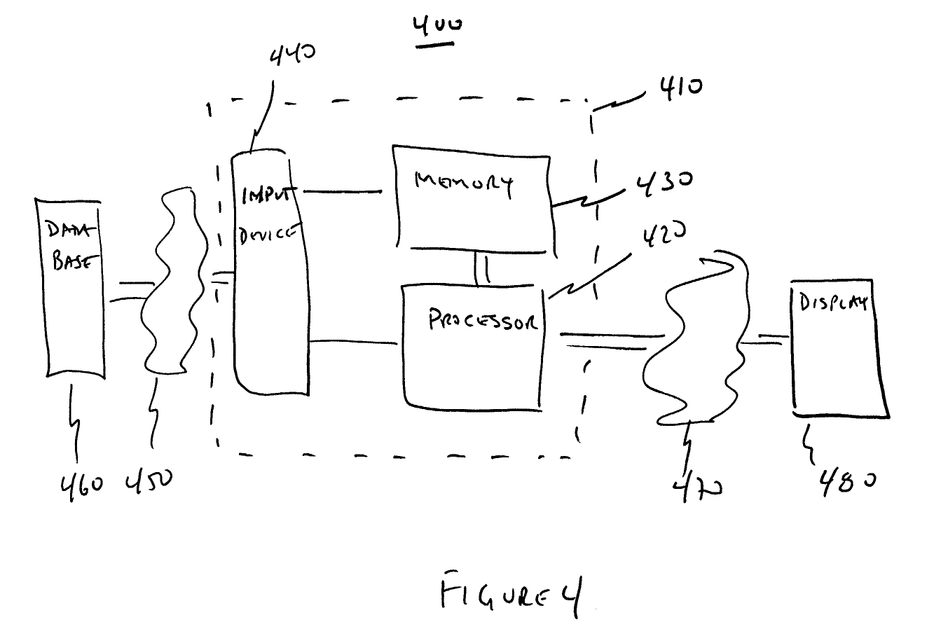

FIG. 4 illustrates an exemplary system 400 for practicing the principles of the invention. In this exemplary system, processor 420 is in communication with memory 430 and input device 440. Processor 420 may be any handheld calculator, special purpose or general purpose processing system that can perform the operations illustrated in FIG. 3. For example, processor 420 may include code, which when executed, performs the operations illustrated in FIG. 3. The code may be contained in memory 430. Similarly, the operations illustrated in FIG. 3 may be performed sequentially or in parallel using different processors to determine specific values. Input device 440 in this exemplary example, receives data from data base 460 over a network 450 and the data may be immediately accessible by processor 420 or may be stored in memory 430. As will be appreciated, input device 440 may also allow for manual input, such as a keyboard or keypad entry or may read data from magnetic or optical medium.

After processing the input data, processor may display the resultant effectiveness on display 480 via network 470. As will be appreciated, networks 450 and 480 may be an internal network among the components, e.g., ISA bus, microchannel bus, PCMCIA bus, etc., or an external network, such as a Local Area Network, Wide Area Network, POTS network, or the Internet.

Although the invention has been described and pictured in a preferred form with a certain degree of particularity, with regard to the present invention will be described as it relates particularly to Statement 133 of the Financial Accounting Standards Board (FASB), it is understood that the present disclosure of the preferred form, has been made only by way of example, and that numerous changes in the details of construction and combination and arrangement of parts may be made without departing from the spirit and scope of the invention as hereinafter claimed. Further, it should be understood that the present invention is appropriate and applicable for determining how effectively any hedging vehicle reduces the volatility in value of any hedged item.

It is intended that the patent shall cover by suitable expression in the appended claims, whatever features of patentable novelty exist in the invention disclosed.

We claim:

1. A method for determining an effectiveness of a hedge on a hedged item, said method comprising the steps of:
determining a standard deviation of changes in value of said hedged item over a known time frame;
determining a standard deviation of a combination of said changes in value of said hedged item and changes in value of a hedging vehicle over said known time frame; and,
determining a ratio between said standard deviation of changes in value of said hedged item and said standard deviation of changes in value of said hedged item and changes in value of said hedging vehicle.

2. The method as recited in claim 1, said method further comprising the step of:
determining a volatility measure as a complement of said ratio.

3. The method as recited in claim 1 wherein said known time period is selected from the group of monthly, quarterly, yearly.

4. The method as recited in claim 1 wherein effectiveness is determined when said ratio is below a known level.

5. The method as recited in claim 2 wherein effectiveness is determined when said measure is above a known level.

6. The method as recited in claim 4 wherein said known level based upon conventional financial considerations.

7. The method as recited in claim 5 wherein said known level based upon conventional financial considerations.

8. A system for determining an effectiveness of a hedge on a hedged item, said system comprising:
a processor in communication with a memory;
said processor operable to execute:
code for determining a standard deviation of changes in value of said hedged item over a known time frame;
code for determining a standard deviation of a combination of said changes in value of said hedged item and changes in value of a hedging vehicle over said known time frame; and,
code for determining a ratio between said standard deviation of changes in value of said hedged item and said standard deviation of changes in value of said hedged item and changes in value of said hedging vehicle.

9. The system as recited in claim 8, wherein said processor is further operable to execute:
code for determining a volatility measure as a complement of said ratio.

10. The system as recited in claim 8 wherein said known time period is selected from the group of monthly, quarterly, yearly.

11. The system as recited in claim 8 wherein effectiveness is determined when said ratio is below a known level.

12. The system as recited in claim 9 wherein effectiveness is determined when said measure is above a known level.

13. The system as recited in claim 11 wherein said known level based upon conventional financial considerations.

14. The system as recited in claim 12 wherein said known level based upon conventional financial considerations.

15. The system as recited in claim 8 further comprising:
means for inputting said change in value data.

16. The system as recited in claim 15 wherein said means for inputting is selected from the group of keyboard entry, magnetic medium, optical medium, electronic transfer over a network.

17. The system as recited as in claim 11 further comprising:
means for inputting said known level.

18. The system as recited in claim 17 wherein said means for inputting is selected from the group of keyboard entry, magnetic medium, optical medium, electronic transfer over a network.

19. The system as recited as in claim 12 further comprising:
means for inputting said known level.

20. The system as recited in claim 19 wherein said means for inputting is selected from the group of keyboard entry, magnetic medium, optical medium, electronic transfer over a network.

21. The system as recited in claim 15 wherein said processor is in communication with said input means.

22. The system as recited in claim 15 wherein said input means is in communication with said memory.

23. The system as recited in claim 8 further comprising:
means for displaying said ratio.

24. The system as recited in claim 9 further comprising:
means for displaying said measure.

25. The system as recited in claim 11 further comprising:
means for displaying said effectiveness.

26. The system as recited in claim 12 further comprising:
means for displaying said effectiveness.
